(19) United States
(12) Patent Application Publication
(10) Pub. No.: US 2025/0236125 A1
(43) Pub. Date: Jul. 24, 2025

(54) PRINTING CASSETTE INCLUDING HELICAL GEAR AS OUTPUT GEAR CONFIGURED TO GENERATE THRUST LOAD IN AXIAL DIRECTION THEREOF

(71) Applicant: BROTHER KOGYO KABUSHIKI KAISHA, Nagoya (JP)

(72) Inventors: Yoshimi IWAMOTO, Nagoya (JP); Yuya TAGAMI, Owariasahi (JP); Akinori HANADA, Nagoya (JP)

(21) Appl. No.: 19/174,520

(22) Filed: Apr. 9, 2025

Related U.S. Application Data
(63) Continuation of application No. PCT/JP2023/035647, filed on Sep. 29, 2023.

(30) Foreign Application Priority Data
Oct. 11, 2022 (JP) 2022-163374

(51) Int. Cl. B41J 15/04; B41J 3/407; B41J 11/00; B41J 32/00

(52) U.S. Cl. CPC B41J 15/044; B41J 3/4075; B41J 11/009; B41J 15/042; B41J 32/00

(57) ABSTRACT

A printing cassette includes: a tape roll including a tape to be used for printing, the tape being wound about an axis parallel to a first direction; an input part into which a drive force from outside is to be inputted; and an output gear rotatable about a rotational axis parallel to a second direction for externally outputting the drive force inputted in the input part. The input part overlaps the tape roll when viewed in a direction parallel to the first direction. The output gear is a helical gear configured to generate a thrust load in the second direction when rotating. At least a part of the output gear overlaps the tape roll from the same side as the input part when viewed in the direction parallel to the first direction.

### REFERENCE TO RELATED APPLICATIONS

This application is a continuation application of International Application No. PCT/JP2023/035647 filed on Sep. 29, 2023, which claims priority from Japanese Patent Application No. 2022-163374 filed on Oct. 11, 2022. The entire contents of the above-mentioned earlier applications are incorporated herein by reference.

### BACKGROUND ART

In a printing device configured to perform printing on a tape, a printing cassette accommodating the tape is configured to be attached to and detached from a printing device body. In such printing cassettes, there has been known a configuration where a printing cassette has an output gear configured to mesh a device-side gear (i.e., a platen gear) provided at the printing device body.

### SUMMARY

In view of the foregoing, it is an object of the present disclosure to provide a printing cassette with a novel structure.

In order to attain the above and other object, according to one aspect, the present disclosure provides a printing cassette including: a tape roll including a tape to be used for printing, the tape being wound about an axis parallel to a first direction; an input part into which a drive force from outside is to be inputted; and an output gear rotatable about a rotational axis parallel to a second direction for externally outputting the drive force inputted in the input part. The input part overlaps the tape roll when viewed in a direction parallel to the first direction. The output gear is a helical gear configured to produce a thrust load in the second direction when rotating. At least a part of the output gear overlaps the tape roll from the same side as the input part when viewed in the direction parallel to the first direction.

With this structure, a printing cassette with a novel structure can be provided.

### BRIEF DESCRIPTION OF DRAWINGS

FIG. 1 is a schematic perspective view illustrating a printing device according to one embodiment.

FIG. 2A is a schematic top view illustrating a printing device body in the printing device of FIG. 1.

FIG. 2B is a schematic perspective view illustrating the printing device body of FIG. 2A.

FIG. 3 is a schematic perspective view illustrating a platen roller and a drive transmission mechanism in the printing device of FIG. 1.

FIG. 4A is a schematic view of a printing cassette in the printing device of FIG. 1.

FIG. 4B is another schematic view of a printing cassette in the printing device of FIG. 1.

FIG. 5 is an exploded schematic perspective view of the printing cassette of FIG. 4A.

FIG. 6 is a schematic plan view illustrating an internal structure of a first frame part in the printing cassette of FIG. 4A.

FIG. 7 is a schematic perspective view illustrating an internal structure of a second frame part in the printing cassette of FIG. 4A.

FIG. 8A is a schematic cross-sectional view taken along a line VIIIA-VIIIA in FIG. 4A.

FIG. 8B is a schematic cross-sectional view taken along a line VIIIB-VIIIB in FIG. 8A.

FIG. 8C is a schematic cross-sectional view taken along a line VIIIC-VIIIC in FIG. 8B.

FIG. 8D is a schematic cross-sectional view taken along a line VIIID-VIIID in FIG. 8C.

FIG. 9 is a schematic cross-sectional view illustrating a meshing state between an output gear and the platen roller in the printing cassette of FIG. 4A.

FIG. 10 is a schematic front view of the printing cassette of FIG. 4A.

FIG. 11 is a schematic bottom view of the printing cassette of FIG. 4A.

FIG. 12 is a schematic side view of the printing cassette of FIG. 4A.

FIG. 13 is a partially-enlarged schematic view of the output gear and in the vicinity thereof in the printing cassette of FIG. 4A.

FIG. 14 is a schematic perspective view of a drive transmission mechanism in a different embodiment from the embodiment of FIG. 3.

FIG. 15 is a schematic front view of a printing cassette including the drive transmission mechanism of FIG. 14.

FIG. 16 is a schematic perspective view of a drive transmission mechanism in another different embodiment from the embodiment of FIG. 3.

FIG. 17 is a schematic front view of a printing cassette including the drive transmission mechanism of FIG. 16.

FIG. 18 is a schematic bottom view of the printing cassette of FIG. 17.

### DESCRIPTION

### 1. First Embodiment

### [1-1. Configuration]

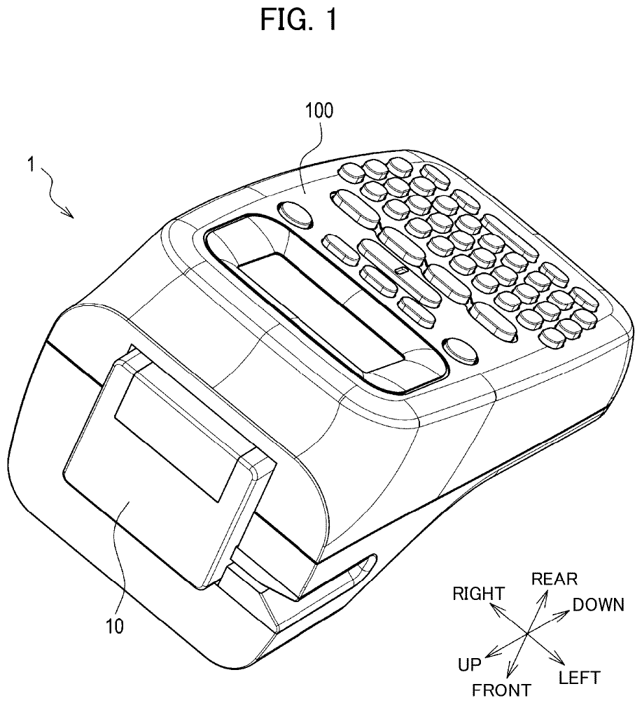

A printing device 1 illustrated in FIG. 1 includes a printing cassette 10, and a printing device body 100. The printing device 1 is a device configured to perform printing on a printing tape 11A.

In the present embodiment, a direction parallel to axis of a printing tape roll 11 will be called an up-down direction (an example of a first direction and a second direction); among directions orthogonal to the up-down direction, a direction parallel to a direction in which the printing tape 11A is to be discharged through a discharge opening 32C will be called a left-right direction; and a direction orthogonal to both the up-down direction and the left-right direction will be called a front-rear direction.

Further, in the present embodiment, “overlapping in the up-down direction” signifies “overlapping when viewed in a direction parallel to the up-down direction” and, more specifically means “overlapping in a projection view that is projected onto a virtual plane orthogonal to the up-down direction.” The same applies to other directions.

### <Printing Device Body>

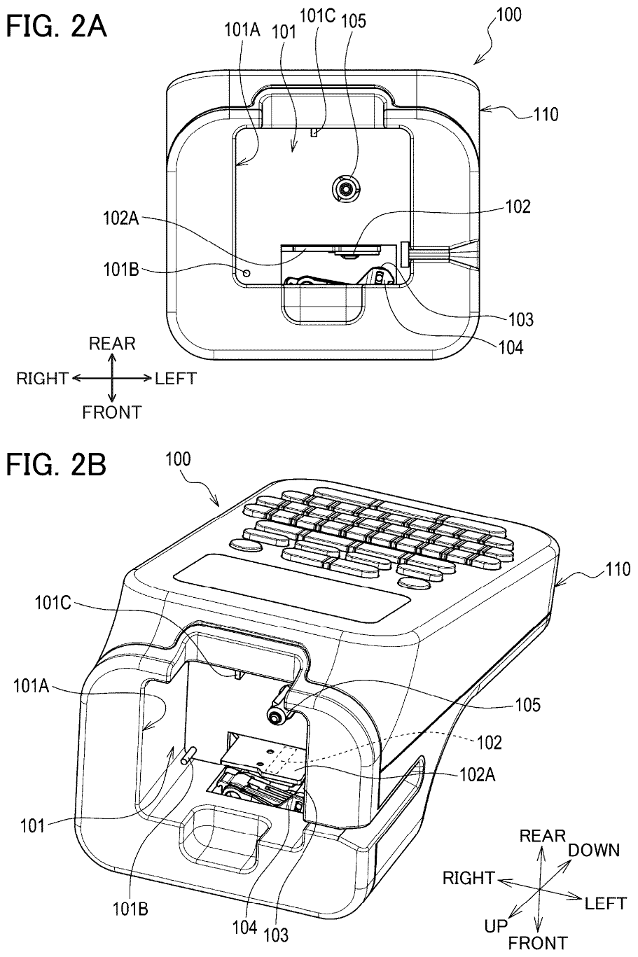

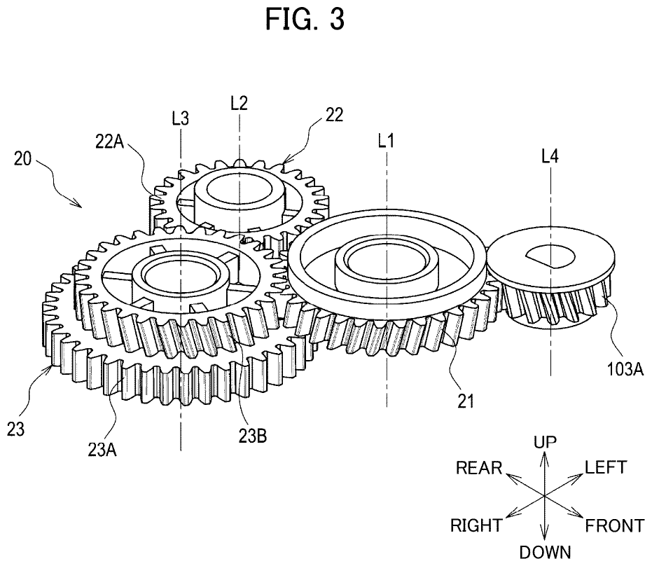

As illustrated in FIGS. 2A and 2B, the printing device body 100 includes a cassette accommodation part 101, a print head 102, a platen roller 103, a platen gear 103A (see FIG. 3), a roller holder 104, a drive shaft 105, and a housing 110.

### (Cassette Accommodation Part)

The cassette accommodation part 101 is a recess to which the printing cassette 10 is to be attached. The cassette accommodation part 101 has a function for positioning of the printing cassette 10.

The cassette accommodation part 101 has an opening 101A formed in the housing 110. The printing cassette 10 is inserted through the opening 101A to be accommodated inside the cassette accommodation part 101.

### (Print Head)

The print head 102 is arranged inside the cassette accommodation part 101. The print head 102 has a plurality of heat-generating elements whose heating is individually controlled. The print head 102 is held by a plate-shaped holding member 102A.

### (Platen Roller)

The platen roller 103 is arranged, inside the cassette accommodation part 101, near the print head 102 so as to oppose the print head 102. The platen roller 103 is pivotable in directions toward and away from the print head 102. A rotational axis of the platen roller 103 is parallel to the up-down direction.

### (Platen Gear)

The platen gear 103A (an example of a device-side gear) illustrated in FIG. 3 is coupled to the platen roller 103. The platen gear 103A meshes with an output gear 21 of the printing cassette 10 attached to the cassette accommodation part 101.

The platen gear 103A has angled teeth that mesh with the output gear 21. Specifically, the platen gear 103A is a single-stage helical gear with external teeth. The helical direction of the angled teeth of the platen gear 103A is left-handed. A rotational axis L4 of the platen gear 103A is coincident with the rotational axis of the platen roller 103. The platen gear 103A is pivotable together with the platen roller 103.

### (Roller Holder)

The roller holder 104 illustrated in FIG. 2B holds the platen roller 103. The roller holder 104 is attached to the housing 110 such that the roller holder 104 is pivotable relative to the housing 110 in the front-rear direction.

### (Drive Shaft)

The drive shaft 105 is inserted into a take-up spool 16 and an input gear 22 of the printing cassette 10. The drive shaft 105 inputs a drive force into the printing cassette 10 for rotating the take-up spool 16 and input gear 22.

The drive shaft 105 is arranged inside the cassette accommodation part 101. A rotational axis of the drive shaft 105 is parallel to the up-down direction. The drive shaft 105 is to be rotated about the rotational axis by a drive source (not illustrated) configured by a combination of a motor and gears, for example.

### <Printing Cassette>

The printing cassette 10 accommodates the printing tape 11A. The printing cassette 10 can be attached to on and detached from the printing device body 100. Replacement of the printing cassette 10 can realize replenishment of the printing tape 11A and change of the type (such as size, color, and material) of printing tape 11A.

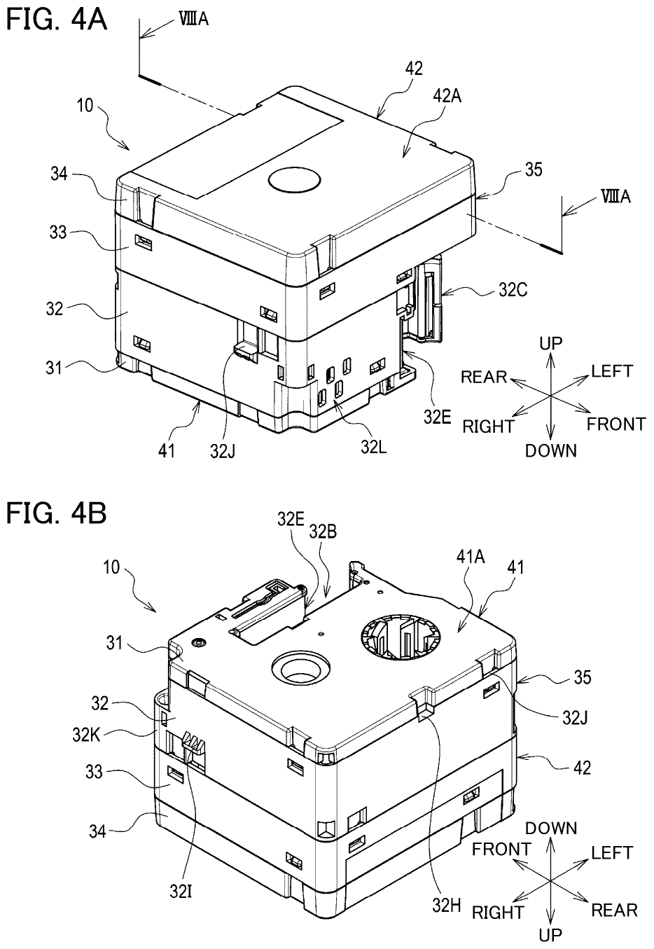

As illustrated in FIGS. 4A and 4B, the printing cassette 10 includes a main case 35 that accommodates therein at least a part of the printing tape 11A and at least a part of an ink ribbon 14A (i.e., an auxiliary tape).

The main case 35 has a first case 41 and a second case 42. Each of the first case 41 and second case 42 is a rectangular parallelepiped having sides that are parallel to the up-down direction, sides that are parallel to the front-rear direction, and sides that are parallel to the left-right direction. In other words, the main case 35 has a rectangular outer shape when viewed in the up-down direction.

The first case 41 is coupled to the second case 42 so as to protrude downward from a bottom surface of the second case 42. The main case 35 can be inserted into and removed from the cassette accommodation part 101 in the up-down direction in such an orientation that the first case 41 faces toward a bottom surface of the cassette accommodation part 101.

Inside the main case 35A, there is provided a conveying path for conveying the printing tape 11A spanning between the second case 42 and first case 41.

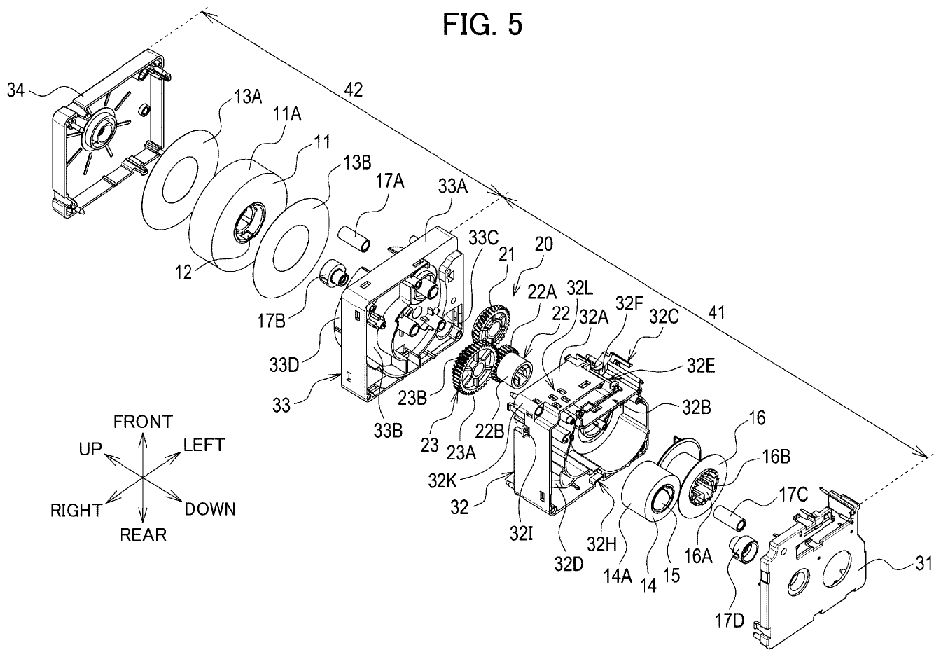

As illustrated in FIG. 5, the printing cassette 10 includes the printing tape roll 11, a first supply spool 12, an auxiliary tape roll 14, a second supply spool 15, the take-up spool 16, and a drive transmission mechanism 20.

### (Printing Tape Roll)

The printing tape roll 11 includes a strip of the printing tape 11A to be used for printing, the printing tape 11A being wound over the first supply spool 12 about an axis of the printing tape roll 11. On a surface of the printing tape 11A, printing is performed using the print head 102 of the printing device body 100 and the ink ribbon 14A. The axis of the printing tape roll 11 is parallel to the up-down direction.

Two spacer films 13A and 13B are arranged on respective outer sides of the printing tape roll 11 in the up-down direction so as to sandwich the printing tape roll 11. The spacer films 13A and 13B are arranged between the printing tape roll 11 and a second cover part 34 and between the printing tape roll 11 and a second frame part 33, respectively. The printing tape 11A drawn off the printing tape roll 11 is guided by a first roller 17A and a second roller 17C.

### (First Supply Spool)

The first supply spool 12 is rotatable about a rotational axis parallel to the up-down direction. The first supply spool 12 supplies the printing tape 11A to the print head 102 by rotating as the platen roller 103 of the printing device body 100 conveys the printing tape 11A.

The rotational axis of the first supply spool 12 is coincident with the axis of the printing tape roll 11. A rotational resistance is applied to the first supply spool 12 by a clutch spring held in a first clutch spring holder 17B.

### (Auxiliary Tape Roll)

The auxiliary tape roll 14 includes a strip of the ink ribbon 14A to be used for printing on the printing tape 11A, the ink ribbon 14A being wound over the second supply spool 15 about an axis of the auxiliary tape roll 14.

The ink ribbon 14A is overlaid on the printing tape 11A within a head opening 32B, and is to be subject to printing by the print head 102. After being used for printing, the ink ribbon 14A is taken up on the take-up spool 16.

When viewed in the up-down direction, the auxiliary tape roll 14 overlaps the printing tape roll 11 from the same side as the input gear 22 (i.e., from the bottom side). Further, at least a part of the auxiliary tape roll 14 is arranged to overlap the printing tape roll 11 in the up-down direction. Further, the auxiliary tape roll 14 is arranged to overlap the discharge opening 32C in a direction orthogonal to an axial direction of the output gear 21 (i.e., in a radial direction of the output gear 21).

### (Second Supply Spool)

The second supply spool 15 is rotatable about a rotational axis thereof. The rotational axis of the second supply spool 15 is parallel to the up-down direction.

The second supply spool 15 supplies the ink ribbon 14A to the print head 102 by rotating as the take-up spool 16 takes up the ink ribbon 14A. A rotational resistance is applied to the second supply spool 15 by a clutch spring held in a second clutch spring holder 17D.

### (Take-up Spool)

The take-up spool 16 is rotatable about a rotational axis thereof. The rotational axis of the take-up spool 16 is parallel to the rotational axis of the second supply spool 15.

The take-up spool 16 is cylindrical and has a hollow area defined by an inner circumferential surface 16A. Splines 16B are provided on the inner circumferential surface 16A of the take-up spool 16. The drive shaft 105 of the printing device body 100 is to be coupled with the splines 16B. The take-up spool 16 takes up the ink ribbon 14A when rotated by the drive shaft 105.

### (Drive Transmission Mechanism)

The drive transmission mechanism 20 transmits a drive force from the drive shaft 105 to the platen roller 103 via the platen gear 103A when the printing cassette 10 is attached to the printing device body 100. The drive transmission mechanism 20 includes the output gear 21, the input gear 22, and an idle gear 23.

The printing tape roll 11, drive transmission mechanism 20, and take-up spool 16 are arranged in the up-down direction in order the printing tape roll 11, drive transmission mechanism 20, and take-up spool 16.

### (Output Gear)

The output gear 21 is an external gear for externally outputting the drive force to be used for conveying the printing tape 11A (i.e., the drive force inputted into the input gear 22).

Specifically, the output gear 21 meshes with the platen gear 103A of the printing device body 100, as illustrated in FIG. 3, and transmits the drive force for conveying the printing tape 11A to the platen gear 103A.

The output gear 21 has angled teeth to be meshed with the angled teeth of the platen gear 103A. A rotational axis L1 of the output gear 21 is parallel to the rotational axis of the second supply spool 15 and the rotational axis L4 of the platen gear 103A.

When rotating, the output gear 21 generates a thrust load in a direction parallel to the rotational axis L1 of the output gear 21 (i.e., in the up-down direction). The direction of the thrust load is either upward or downward and is determined by the helical direction of the angled teeth of the output gear 21 and the rotating direction of the output gear 21.

Specifically, the output gear 21 is a single-stage helical gear with external gear teeth. The helical direction of the angled teeth of the output gear 21 is such a direction for generating a thrust load that pushes the output gear 21 downward when the output gear 21 is meshed with the platen gear 103A (i.e., right-handed).

In other words, due to the meshing engagement of the output gear 21 with the platen gear 103A, the output gear 21 has such a handedness that a thrust load is generated in an insertion direction of the main case 35 into the printing device body 100 (i.e., downward) when the output gear 21 rotates in a direction for transmitting the drive force to convey the printing tape 11A toward a drawn-out part 32E. The helix angle of the output gear 21 is not less than 20 degrees and not more than 30 degrees.

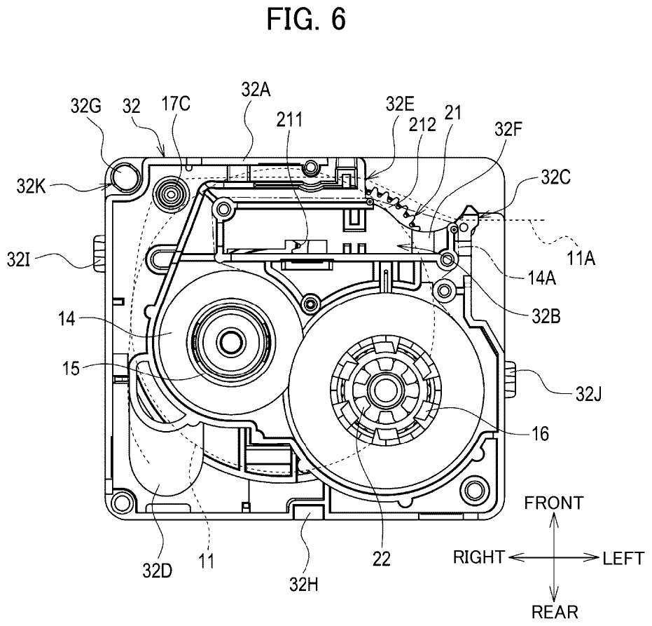

The output gear 21 is partially exposed in a space communicating with the head opening 32B. As illustrated in FIG. 6, the output gear 21 has a first portion 211 housed inside the main case 35, and a second portion 212 exposed outside the main case 35.

The second portion 212 engages with the platen gear 103A in the space communicating with the head opening 32B in a state where the printing cassette 10 is attached to the printing device body 100 (i.e., in a state where the main case 35 is housed in the cassette accommodation part 101). The second portion 212 is arranged at the same position in the left-right direction as a part of the printing tape 11A drawn out through the drawn-out part 32E.

The gear teeth on the second portion 212 are angled such that an end of a gear tooth nearer the drawn-out part 32E in the up-down direction is positioned farther downstream in a drawn-out direction of the printing tape 11A than an end of the gear teeth farther away from the drawn-out part 32E in the up-down direction.

When viewed in the up-down direction, at least a part of the output gear 21 overlaps the printing tape roll 11 from the same side as the input gear 22 (i.e., from the bottom; see FIG. 6).

### (Input Gear)

The input gear 22 is indirectly engaged with the output gear 21 via the idle gear 23. The input gear 22 is an input part for indirectly transmitting the drive force inputted from the printing device body 100 to the output gear 21.

As illustrated in FIG. 5, the input gear 22 has an external gear 22A, and a spool 22B. The spool 22B is a cylindrical internal gear with spines provided on an inner circumferential surface thereof. The spool 22B is fixed to one side surface of the external gear 22A. The external gear 22A is rotatable together with the spool 22B by the drive force inputted into the spool 22B.

A rotational axis L2 of the input gear 22 (i.e., rotational axes of the external gear 22A and spool 22B) is colinear with the rotational axis of the take-up spool 16. The rotational axis L2 of the input gear 22 is also parallel to the rotational axis L1 of the output gear 21.

The rotational axis L2 of the input gear 22 overlaps the hollow area in the take-up spool 16 in the up-down direction. Accordingly, the drive shaft 105 is simultaneously inserted in the take-up spool 16 and the input gear 22 in the state where the printing cassette 10 is attached to the printing device body 100. As a result, the input gear 22, although not directly coupled with the take-up spool 16, is rotated together with the take-up spool 16 by the drive shaft 105.

When viewed in the up-down direction, the input gear 22 overlaps the printing tape roll 11 from the same side as the output gear 21 (i.e., from the bottom; see FIG. 6).

### (Idle Gear)

The idle gear 23 is drivingly connected to (i.e., engaged with) the input gear 22 and output gear 21 and transmits the drive force inputted into the input gear 22 to the output gear 21.

As illustrated in FIG. 3, the idle gear 23 is a stepped gear configured of an upstream gear 23A engaged with the input gear 22, and a downstream gear 23B engaged with the output gear 21. The upstream gear 23A and downstream gear 23B are arranged coaxially with each other. The upstream gear 23A is a spur gear with external teeth and is in engagement with the input gear 22.

The downstream gear 23B is an external helical gear that meshes with the output gear 21. The helical direction of the downstream gear 23B is left-handed, which is opposite the output gear 21. The downstream gear 23B has a diameter smaller than a diameter of the upstream gear 23A. Further, in the up-down direction, the downstream gear 23B is arranged closer to the printing tape roll 11 (i.e., upward) than the upstream gear 23A is thereto.

A rotational axis L3 of the idle gear 23 is parallel to the rotational axis L1 of the output gear 21. The idle gear 23 transmits the drive force to the output gear 21 while reducing a rotational speed of the drive force inputted in the input gear 22. That is, the drive transmission mechanism 20 includes a reduction mechanism whose reduction ratio is set to a transmission ratio obtained by dividing a rotational speed of the input gear 22 by a rotational speed of the output gear 21.

### (Main Case)

As illustrated in FIG. 5, the main case 35 has a first cover part 31, a first frame part 32, the second frame part 33, and the second cover part 34.

The first cover part 31 constitutes a bottom end portion of the printing cassette 10. The first frame part 32 is arranged above the first cover part 31 and is coupled to the first cover part 31 in the up-down direction. The second frame part 33 is arranged above the first frame part 32 and is coupled to the first frame part 32 in the up-down direction. The second cover part 34 constitutes a top end portion of the printing cassette 10. The second cover part 34 is coupled to the second frame part 33 in the up-down direction.

The first cover part 31, first frame part 32, and a portion of the second frame part 33 constitute the first case 41, which houses the auxiliary tape roll 14, second supply spool 15, take-up spool 16, and drive transmission mechanism 20. In the up-down direction, the first case 41 is arranged at a different position from (specifically, lower than) the printing tape roll 11. The first case 41 has the discharge opening 32C.

The auxiliary tape roll 14, second supply spool 15, and take-up spool 16 are arranged in a space enclosed by the first cover part 31 and first frame part 32. The drive transmission mechanism 20 is arranged in a space enclosed by the first frame part 32 and second frame part 33. In other words, the drive transmission mechanism 20 is arranged between the printing tape roll 11 and the auxiliary tape roll 14 in the up-down direction.

The second cover part 34 and second frame part 33 constitute the second case 42 that houses the printing tape roll 11. In other words, the printing tape roll 11 is arranged in a space enclosed by the second cover part 34 and second frame part 33.

The first frame part 32 has a first side wall 32A, the head opening 32B, the discharge opening 32C, a second guide part 32D, the drawn-out part 32E, a first contact part 32F, a second contact part 32G (see FIG. 6), a third contact part 32H, a first additional contact part 32I, a second additional contact part 32J, and a detection target part 32L. The first side wall 32A constitutes outer side surfaces of the main case 35 that are parallel to the up-down direction.

The head opening 32B is a part that is cut out from the first side wall 32A. The head opening 32B is arranged to overlap the discharge opening 32C in a direction orthogonal to the axial direction of the output gear 21 (i.e., in the radial direction of the output gear 21).

The head opening 32B is a space in which the print head 102 and the holding member 102A holding the print head 102 are arranged in a state where the printing cassette 10 is attached to the printing device body 100. In other words, the head opening 32B is configured of a printing space in which printing is performed, and a recess that communicates with the printing space in the left-right direction.

In the head opening 32B, printing on the printing tape 11A by the print head 102 is performed. The head opening 32B is open on the bottom of the printing cassette 10 so that the print head 102 can be inserted into the head opening 32B from below.

As illustrated in FIG. 6, the printing tape 11A and the ink ribbon 14A are spanned in the left-right direction across a leftward region in the printing space of the head opening 32B. In the head opening 32B, the printing tape 11A is overlaid on the ink ribbon 14A and is exposed outside the main case 35.

After being printed, the printing tape 11A is discharged outside the main case 35 and printing device 1 through the discharge opening 32C. A direction in which the printing tape 11A is discharged at the discharge opening 32C is leftward. The discharge opening 32C, output gear 21, and printing tape roll 11 are arranged in the up-down direction in order the discharge opening 32C, output gear 21, and printing tape roll 11.

The second guide part 32D is constituted by a part of a column or cylinder. The second guide part 32D is arranged, inside the first side wall 32A, on a conveying path along which the printing tape 11A is to be conveyed.

The printing tape 11A drawn off the printing tape roll 11 inside the second case 42 advances into the first case 41 while running along an outer circumferential surface of the second guide part 32D. The printing tape 11A is subsequently conveyed toward the head opening 32B and discharge opening 32C while making contact with the second roller 17C.

The drawn-out part 32E is an opening through which the printing tape 11A is to be drawn out of the main case 35 by the platen roller 103 in a drawn-out direction along the left-right direction. The printing tape 11A is then conveyed toward the discharge opening 32C while being in contact with the drawn-out part 32E. As a result, a leftward load is generated on the drawn-out part 32E due to a resistance force of the printing tape 11A.

As illustrated in FIGS. 4A and 4B, the drawn-out part 32E is arranged between a first outer surface 41A and a second outer surface 42A. The first outer surface 41A and second outer surface 42A are outermost surfaces of the main case 35 between which the printing tape roll 11 is interposed in the up-down direction. The first outer surface 41A constitutes a bottom surface of the first case 41. The second outer surface 42A constitutes a top surface of the second case 42.

The drawn-out part 32E is arranged downward of the output gear 21. In other words, the drawn-out part 32E is arranged at a position different from a mesh point between the output gear 21 and the platen gear 103A in the up-down direction.

Specifically, the printing tape roll 11, output gear 21, and drawn-out part 32E are arranged in the up-down direction in order the printing tape roll 11, output gear 21, and drawn-out part 32E.

The first contact part 32F, second contact part 32G, third contact part 32H, first additional contact part 32I, and second additional contact part 32J illustrated in FIG. 6 are respectively in contact with inner surfaces of the housing 110 of the printing device body 100 in the up-down direction in a state where the main case 35 is inserted in the cassette accommodation part 101.

That is, the first contact part 32F, second contact part 32G, and third contact part 32H provide positioning of the main case 35 in the up-down direction relative to the cassette accommodation part 101 by respectively contacting corresponding parts of the printing device body 100 from above.

The first contact part 32F, second contact part 32G, third contact part 32H, first additional contact part 32I, and second additional contact part 32J are separated from one another.

The first contact part 32F is arranged to overlap the head opening 32B in the up-down direction. Specifically, the first contact part 32F is arranged upward of the head opening 32B. The first contact part 32F is exposed toward the bottom of the printing cassette 10 through the head opening 32B. The first contact part 32F contacts the holding member 102A inserted in the head opening 32B.

The second contact part 32G is arranged on a corner part of the first frame part 32 when viewed in the up-down direction. Specifically, the second contact part 32G is constituted by a bottom surface of a bottomed cylindrical body 32K. The cylindrical body 32K has an axis parallel to the up-down direction and is arranged on a right front corner of the first frame part 32.

A pin 101B (see FIGS. 2A and 2B) provided in the cassette accommodation part 101 and extending in the up-down direction is inserted in the cylindrical body 32K configuring the second contact part 32G. The second contact part 32G also functions to restrict the main case 35 from rotating inside the cassette accommodation part 101.

The third contact part 32H is constituted by a recess that is recessed upward in a rear side surface of the first side wall 32A. The third contact part 32H contacts a rib 101C (see FIGS. 2A and 2B) provided in the cassette accommodation part 101 and extending in the up-down direction.

The first additional contact part 32I is constituted by a protrusion that protrudes rightward from a right side surface of the first side wall 32A. The first additional contact part 32I contacts a step provided inside the cassette accommodation part 101.

The second additional contact part 32J is constituted by a protrusion that protrudes leftward from a left side surface of the first side wall 32A. The second additional contact part 32J contacts a step provided inside the cassette accommodation part 101.

The detection target part 32L illustrated in FIG. 4A is a part indicating cartridge identification information, and enables the printing device body 100 to detect the cartridge identification information. The detection target part 32L is arranged to overlap the discharge opening 32C in a direction orthogonal to the axial direction of the output gear 21 (i.e., in the radial direction of the output gear 21). Further, the detection target part 32L is arranged on an opposite side of the output gear 21 from the printing tape roll 11 in the up-down direction (i.e., below the output gear 21) and upstream of the output gear 21 in the drawn-out direction of the printing tape 11A.

The detection target part 32L includes holes, recesses, or notches provided in the first side wall 32A. The printing device body 100 detects the cartridge identification information by reading a three-dimensional marker constituted by the holes, recesses, or notches in the detection target part 32L through contact therewith.

The second frame part 33 illustrated in FIG. 5 has a second side wall 33A, a partitioning wall 33B, a first guide part 33C, and a roll frame portion 33D. The second side wall 33A constitutes outer side surfaces of the main case 35 that are parallel to the up-down direction.

The partitioning wall 33B extends in the front-rear direction and left-right direction and has a surface orthogonal to the up-down direction. The partitioning wall 33B is arranged between the printing tape roll 11 and the drive transmission mechanism 20 in the up-down direction, that is, between the first supply spool 12 and the second guide part 32D.

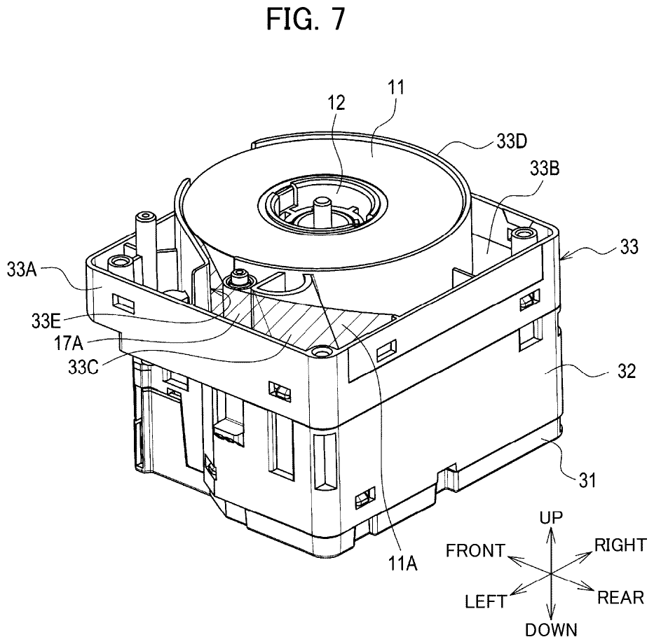

As illustrated in FIG. 7, the first guide part 33C is constituted by a part of a column or cylinder. The first guide part 33C is arranged inside the second side wall 33A on the conveying path of the printing tape 11A in the second case 42.

After being drawn off the printing tape roll 11, the printing tape 11A is conveyed toward the first case 41 while being twisted, by running along an outer circumferential surface of the first guide part 33C.

The first roller 17A is arranged between the printing tape roll 11 and the first guide part 33C (i.e., near a point where the printing tape 11A is drawn off the printing tape roll 11) along the conveying path of the printing tape 11A. The printing tape 11A is mounted over the first roller 17A at an upstream side of the first guide part 33C. The first roller 17A rotates about an axis thereof in accordance with conveyance of the printing tape 11A.

The roll frame portion 33D protrudes upward from the partitioning wall 33B. The roll frame portion 33D surrounds the printing tape roll 11 from radially outside thereof. The printing tape 11A is drawn off the printing tape roll 11 at an opening 33E in the roll frame portion 33D.

### <Conveying Path of the Printing Tape>

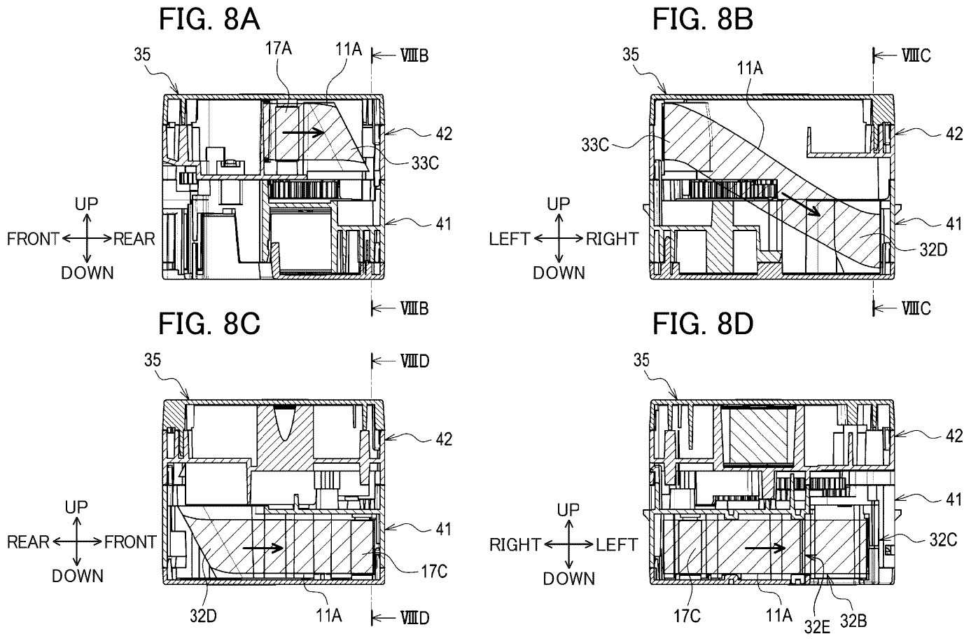

As illustrated in FIGS. 8A, 8B, 8C and 8D, the first guide 33C and second guide part 32D constitute the conveying path for conveying the printing tape 11A from the second case 42 into the first case 41.

Specifically, as illustrated in FIG. 8A, the printing tape 11A drawn off the printing tape roll 11 is conveyed downward and rearward while contacting the first guide 33C from radially outside of the printing tape roll 11.

After passing the first guide 33C, the printing tape 11A is conveyed downward and rightward toward the second guide part 32D, as illustrated in FIG. 8B. The printing tape 11A is spanned over the first guide 33C and second guide part 32D in order the first guide 33C and second guide part 32D. The twist added to the printing tape 11A by the first guide 33C is cancelled by the second guide part 32D.

After reaching the second guide part 32D, the printing tape 11A is conveyed frontward while contacting the second guide part 32D from radially outside of the auxiliary tape roll 14, as illustrated in FIG. 8C.

After moving past the second guide part 32D, the printing tape 11A is conveyed leftward while being guided by the second roller 17C, as illustrated in FIG. 8D. Thereafter, the printing tape roll 11 is discharged through the discharge opening 32C after passing through the drawn-out part 32E and head opening 32B.

### <Conveyance and Printing of Tape in the Printing Device Body>

In a state where the printing cassette 10 is attached to the printing device body 100, the print head 102 is positioned in the head opening 32B to overlap the printing tape 11A and ink ribbon 14A in the front-rear direction.

The printing tape 11A is conveyed by the platen roller 103 to the head opening 32B and is pressed, through the ink ribbon 14A, against the print head 102 where the heat-generating elements are heated. Thus, some of the ink on the surface of the ink ribbon 14A is transferred onto the printing tape 11A to print characters, symbols, and the like on the printing tape 11A.

The platen roller 103 conveys the printed printing tape 11A from inside the printing cassette 10 toward outside thereof through the discharge opening 32C. The platen roller 103 is rotated by the platen gear engaged with the output gear 21. The platen roller 103 is made pivotable, by the roller holder 104, between a position where the platen roller 103 is separated from the printing cassette 10, and a position where the platen gear 103A is engaged with the output gear 21 and the printing tape 11A and ink ribbon 14A are nipped between the platen roller 103 and the print head 102.

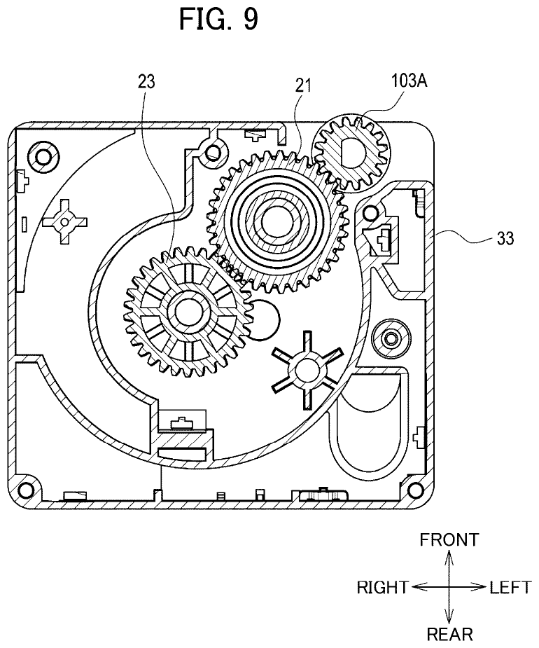

In the state where the main case 35 of the printing cassette 10 is inserted in the cassette accommodation part 101, the drive shaft 105 is engaged with the input gear 22 and the platen gear 103A is engaged with the output gear 21, as illustrated in FIG. 9.

Specifically, in a state where the drive shaft 105 is inserted in the take-up spool 16 and input gear 22 of the printing cassette 10, the platen gear 103A is engaged with the output gear 21 as a result of pivoting of the platen roller 103 toward the head opening 32B of the printing cassette 10.

The output gear 21 is rotated by rotation of the input gear 22 by the drive shaft 105 in the state where the printing cassette 10 is attached. Further, the platen gear 103A rotates by the rotation of the output gear 21, which in turn rotates the platen roller 103.

### <Thrust Loads From Helical Gears>

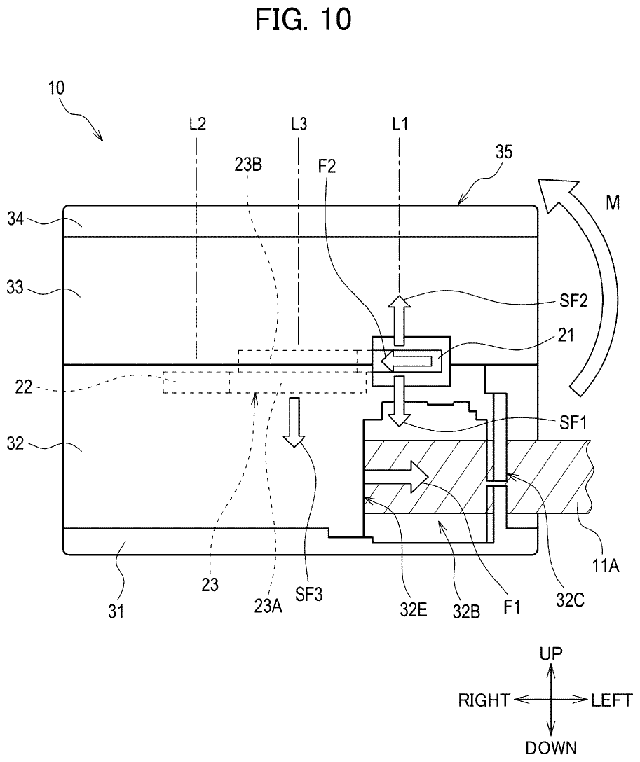

As illustrated in FIG. 10, a resistance force F1 is generated on the drawn-out part 32E of the main case 35 as the printing tape 11A is drawn out of the main case 35. The direction of the resistance force F1 is orthogonal to the up-down direction, and the resistance force F1 includes a leftward component.

Incidentally, in FIG. 10, the output gear 21, input gear 22, and idle gear 23 are depicted schematically at different positions from their actual layout in the main case 35 in order to more clearly illustrate the relationship among the forces in the printing cassette 10.

If the output gear 21, platen gear 103A, and idle gear 23 did not possess angled teeth (i.e., were spur gears), a reaction force F2 would be generated on the output gear 21 at the mesh point between the output gear 21 and platen gear 103A while the output gear 21 and platen gear 103A are meshed and rotating. The direction of this reaction force F2 is orthogonal to the up-down direction, and the reaction force F2 includes a rightward component.

The resistance force F1 and reaction force F2 are generated at different positions in the up-down direction. Accordingly, a counterclockwise moment M indicated in FIG. 10 is to be produced in the printing cassette 10 by the resistance force F1 and the reaction force F2. The moment M acts on the printing cassette 10 to raise a left end of the printing cassette 10 higher than a right end thereof around an axis parallel to the front-rear direction.

By acting on the printing cassette 10 in this way, the moment M lifts up the first contact part 32F of the printing cassette 10 off the cassette accommodation part 101, resulting in unstable positioning of the printing cassette 10.

In contrast, since the output gear 21 and the platen gear 103A have angled teeth as in this embodiment, a downward first thrust load SF1 is generated on a center of the output gear 21 owing to a reaction force resulting from the meshing between the output gear 21 and platen gear 103A and the helix angle of their angled teeth, as illustrated in FIG. 10. The direction of the first thrust load SF1 is parallel to the rotational axis L1.

Further, since the downstream gear 23B of the idle gear 23 has angled teeth, an upward second thrust load SF2 is generated on the center of the output gear 21 while a downward third thrust load SF3 is generated on a center of the downstream gear 23B by the reaction force resulting from the meshing of the output gear 21 with the downstream gear 23B and the helix angle of their angled teeth. The directions of the second thrust load SF2 and third thrust load SF3 are both parallel to the rotational axis L1 of the output gear 21.

The magnitude of the first thrust load SF1 on the upstream side of the output gear 21 is equivalent to the magnitude of the second thrust load SF2 on the downstream side of the output gear 21 or is such a magnitude that is obtained by subtracting transmission loss in the drive force (for example, less than 10%) from the magnitude of the second thrust load SF2. Therefore, a combined thrust load generated at the center of the output gear 21 is either zero or a minute upward load. Accordingly, influence of this combined force on the moment M is negligible.

Since the upstream gear 23A of the idle gear 23 is a spur gear, the third thrust load SF3 generated on the downstream gear 23B is the only load applied to the idle gear 23. The rotational axis L3 of the idle gear 23 passes through such a position where, due to the moment M, a force to detach the main case 35 from the cassette accommodation part 101 (i.e., to move the main case 35 upward, opposite the insertion direction) is received. Accordingly, the third thrust load SF3 restrains the main case 35 from rising.

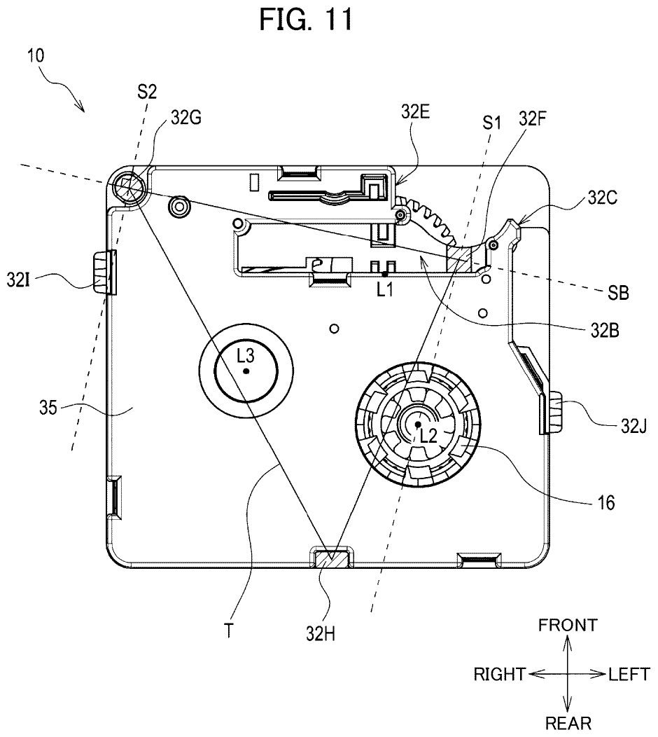

As illustrated in FIG. 11, when viewed in the up-down direction, the rotational axis L3 of the idle gear 23 is positioned between a first virtual plane S1 passing through the first contact part 32F and a second virtual plane S2 passing through the second contact part 32G. The first virtual plane S1 and second virtual plane S2 are both parallel to the up-down direction and orthogonal to a reference virtual plane SB passing through the first contact part 32F and second contact part 32G.

Moreover, when viewed in the up-down direction, there exists a virtual triangle T whose three vertices are respectively contained in the first contact part 32F, second contact part 32G, and third contact part 32H, and the rotational axis L3 of the idle gear 23 is positioned inside the virtual triangle T.

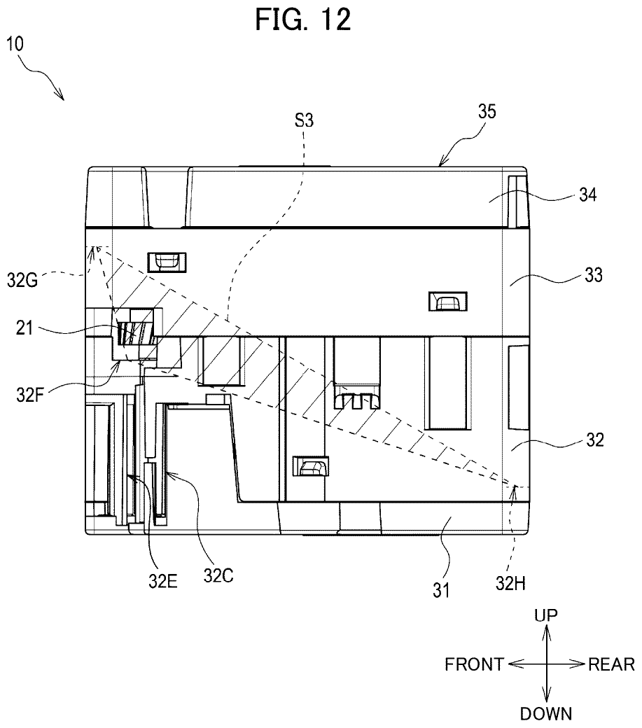

As illustrated in FIG. 12, at least a portion of the output gear 21 is positioned on an opposite side of a third virtual plane S3 from at least a portion of the drawn-out part 32E, the third virtual plane S3 passing through the first contact part 32F, second contact part 32G, and third contact part 32H. Specifically, an entirety of the output gear 21 is positioned upward of the third virtual plane S3, and an entirety of the drawn-out part 32E is positioned downward of the third virtual plane S3.

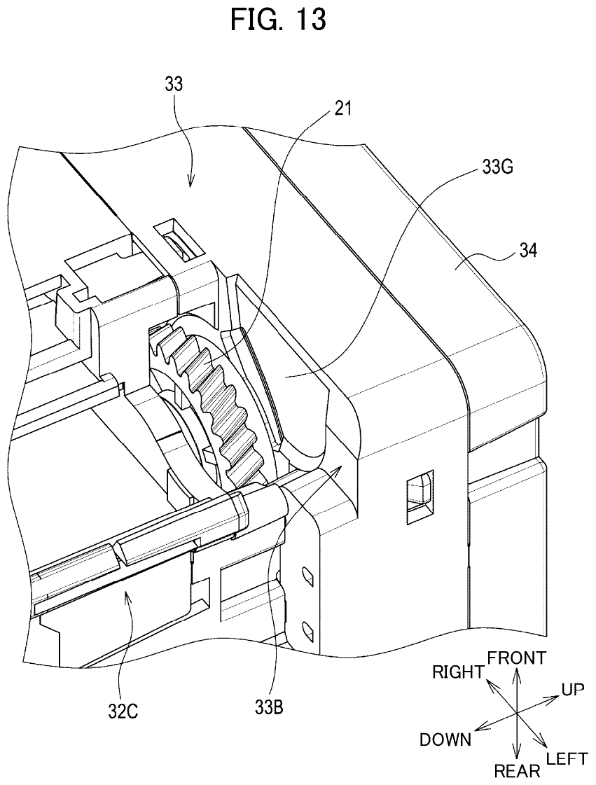

As illustrated in FIG. 13, the partitioning wall 33B of the second frame part 33 may have a recess 33G. The recess 33G is arranged between the printing tape roll 11 and the output gear 21 in the up-down direction. The recess 33G is provided in a wall surface of the partitioning wall 33B, the wall surface crossing the up-down direction.

The recess 33G opposes the platen gear 103A in the state where the main case 35 is inserted in the printing device body 100. A portion of the platen gear 103A enters the recess 33G when the first thrust load SF1 is generated on the output gear 21. The recess 33G is recessed upward so that a bottom surface of the partitioning wall 33B in the area constituting the recess 33G is higher than the bottom surface of the partitioning wall 33B in areas outside the recess 33G.

### 1-2. Advantages

The embodiment described above can obtain the following advantages.

(1a) Since the output gear 21 and the downstream gear 23B of the idle gear 23 are helical gears, the third thrust load SF3 in the axial direction of the output gear 21 is produced in the printing cassette 10 when the output gear 21 meshes with the platen gear 103A. This third thrust load SF3 can restrain the printing cassette 10 from tilting inside the printing device body 100.

(1b) The rotational axis L3 of the idle gear 23 passes through such a position where an upward force resulting from the moment M produced by the reaction force F2 generated on the output gear 21 and the resistance force F1 at the drawn-out part 32E is received. With this configuration, the tilting of the printing cassette 10 can be further suppressed.

(1c) The three vertices of the virtual triangle T are contained in the first contact part 32F, second contact part 32G, and third contact part 32H, respectively, and the rotational axis L3 of the idle gear 23 is positioned inside this virtual triangle T. With this structure, in a case where the third thrust load SF3 becomes excessive relative to the moment M, the load pressing the printing cassette 10 downward is to be distributed among the first contact part 32F, second contact part 32G, and third contact part 32H. As a result, the posture of the printing cassette 10 can be stabilized.

(1d) Since the idle gear 23 is a stepped gear including a helical gear, the structure of the drive transmission mechanism 20 can be simplified while the output gear 21 is configured as a helical gear.

(1e) By positioning the output gear 21 opposite the drawn-out part 32E with respect to the third virtual plane S3 that passes through the first contact part 32F, second contact part 32G, and third contact part 32H from the drawn-out part 32E, tilting of the printing cassette 10 attributed to the moment M produced in the printing cassette 10 can be further restrained.

### 2. Second Embodiment

### 2-1. Configuration

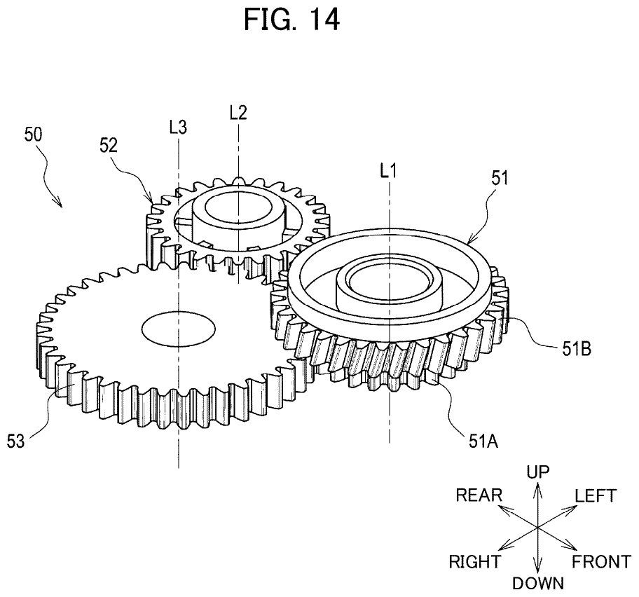

In the printing cassette 10 according to the first embodiment illustrated in FIG. 4A, a drive transmission mechanism 50 illustrated in FIG. 14 is used in place of the drive transmission mechanism 20.

The drive transmission mechanism 50 of this embodiment includes an output part 51, an input gear 52, and an idle gear 53. The input gear 52 is identical to the input gear 22 of the drive transmission mechanism 20 according to the first embodiment.

The output part 51 is to transmit the drive force to the platen gear 103A in the printing device body 100 by meshing with the platen gear 103A. The output part 51 is a stepped gear configured of an auxiliary gear 51A and an output gear 51B arranged coaxially.

The auxiliary gear 51A is a spur gear having external teeth that mesh with the idle gear 53. The output gear 51B is a helical gear having external teeth to be meshed with the platen gear 103A. The output gear 51B has a diameter larger than a diameter of the auxiliary gear 51A. The output gear 51B is arranged upward of the auxiliary gear 51A. The helical direction of angled teeth of the output gear 51B is right-handed.

The rotational axis L1 of the output part 51 is parallel to the rotational axis of the platen gear 103A. In a state where the printing cassette 10 is attached to the printing device body 100, the output gear 51B engages with the platen gear 103A in the space that communicates with the head opening 32B.

The idle gear 53 is a single-stage spur gear having external teeth for transmitting the drive force inputted into the input gear 52 to the output part 51. Specifically, the idle gear 53 is engaged with the input gear 52 and the auxiliary gear 51A of the output part 51. The rotational axis L3 of the idle gear 53 is parallel to the rotational axis L1 of the output part 51.

<Thrust Loads from Helical Gears>

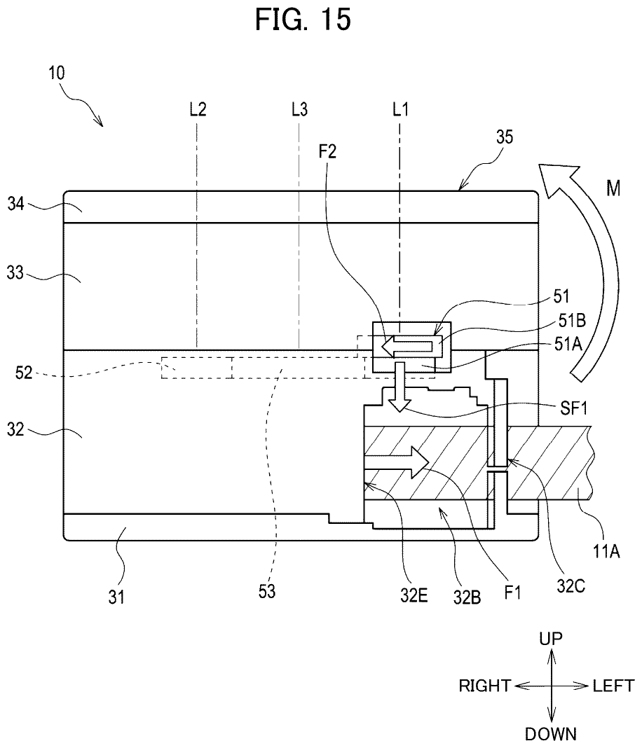

In the present embodiment, as illustrated in FIG. 15, a downward first thrust load SF1 is generated at the center of the output part 51 by a reaction force resulting from the meshing of the output gear 51B of the output part 51 with the platen gear 103A and by the helix angle of their angled teeth. The direction of the first thrust load SF1 is parallel to the rotational axis L1 of the output part 51.

Incidentally, in FIG. 15, the output part 51, input gear 52, and idle gear 53 are depicted schematically at different positions from their actual layout in the main case 35 in order to more clearly illustrate the relationship among the forces in the printing cassette 10.

Since the auxiliary gear 51A of the output part 51 is a spur gear, the first thrust load SF1 generated on the output gear 51B is the only load applied to the output part 51. The rotational axis L1 of the output part 51 passes through such a position where, due to the moment M, a force acting in a direction for detaching the main case 35 from the cassette accommodation part 101 (i.e., upward) is received. Accordingly, the first thrust load SF1 can restrain the main case 35 from rising.

As illustrated in FIG. 11, when viewed in the up-down direction, the rotational axis L1 of the output part 51 is positioned between the first virtual plane S1 passing through the first contact part 32F and the second virtual plane S2 passing through the second contact part 32G. The first virtual plane S1 and second virtual plane S2 are both parallel to the up-down direction and orthogonal to the reference virtual plane SB that passes through the first contact part 32F and second contact part 32G.

Further, when viewed in the up-down direction, there exists a virtual triangle T whose three vertices are respectively contained in the first contact part 32F, second contact part 32G, and third contact part 32H, and the rotational axis L1 of the output part 51 is positioned inside the virtual triangle T. Note that the rotational axis L1 of the output part 51 is the closest to the first contact part 32F among the first contact part 32F, second contact part 32G, and third contact part 32H.

### 2-2. Advantages

The embodiment described above obtains the following advantages.

(2a) Since the output gear 51B is a helical gear, the first thrust load SF1 in the axial direction of the output part 51 is produced in the printing cassette 10 when the output gear 51B is meshed with the platen gear 103A. The first thrust load SF1 can restrain the printing cassette 10 from tilting inside the printing device body 100.

(2b) The rotational axis L1 of the output part 51 passes through a position where an upward force resulting from the moment M that is produced by the reaction force F2 generated at the output part 51 and the resistance force F1 at the drawn-out part 32E is received. This configuration can further contribute to suppression of the tilting of the printing cassette 10.

(2c) The three vertices of the virtual triangle T are contained in the first contact part 32F, second contact part 32G, and third contact part 32H, respectively, and the rotational axis L1 of the output part 51 is located inside this virtual triangle T. With this configuration, in a case where the first thrust load SF1 becomes excessive relative to the moment M, the load pressing the printing cassette 10 downward is to be distributed among the first contact part 32F, second contact part 32G, and third contact part 32H. As a result, the posture of the printing cassette 10 can be stabilized.

(2d) In the drive transmission mechanism 50, only the output part 51 has angled teeth. This configuration can suppress generation of a thrust load in a direction opposite the thrust load of the output part 51 in the printing cassette 10. Hence, the tilting of the printing cassette 10 can be further restrained.

### 3. Third Embodiment

### 3-1. Configuration

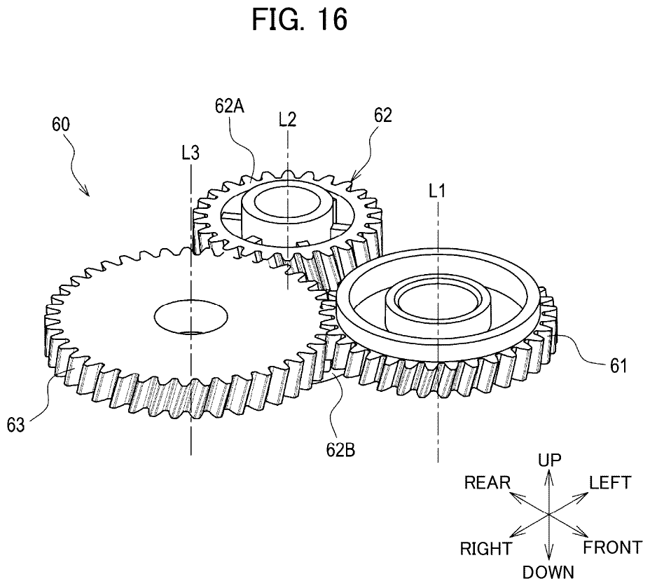

In the printing cassette 10 according to the first embodiment illustrated in FIG. 4A, a drive transmission mechanism 60 illustrated in FIG. 16 is used in place of the drive transmission mechanism 20.

The drive transmission mechanism 60 of this embodiment includes an output gear 61, an input gear 62, and an idle gear 63. The output gear 61 is identical to the output gear 21 of the drive transmission mechanism 20 in the first embodiment.

The input gear 62 is an input part that is indirectly engaged with the output gear 61 via the idle gear 63 and that is configured to indirectly transmit the drive force received from the printing device body 100 to the output gear 61. The input gear 62 includes an external gear 62A, and a spool 62B. The spool 62B is identical to the spool 22B of the input gear 22 according to the first embodiment.

The external gear 62A is rotatable together with the spool 62B by the drive force inputted into the spool 62B. The external gear 62A is a helical gear that meshes with the idle gear 63. The helical direction of the external gear 62A is right-handed, as with the output gear 61. The rotational axis L2 of the input gear 62 (i.e., the rotational axis of the external gear 62A) is parallel to the rotational axis L1 of the output gear 61.

The idle gear 63 is a single-stage helical gear having external teeth for transmitting the drive force inputted into the input gear 62 to the output gear 61. Specifically, the idle gear 63 is meshed with the output gear 61 and the external gear 62A of the input gear 62. The helical direction of the idle gear 63 is left-handed, which is opposite the output gear 61. The rotational axis L3 of the idle gear 63 is parallel to the rotational axis L1 of the output gear 61.

### <Thrust Loads From Helical Gears>

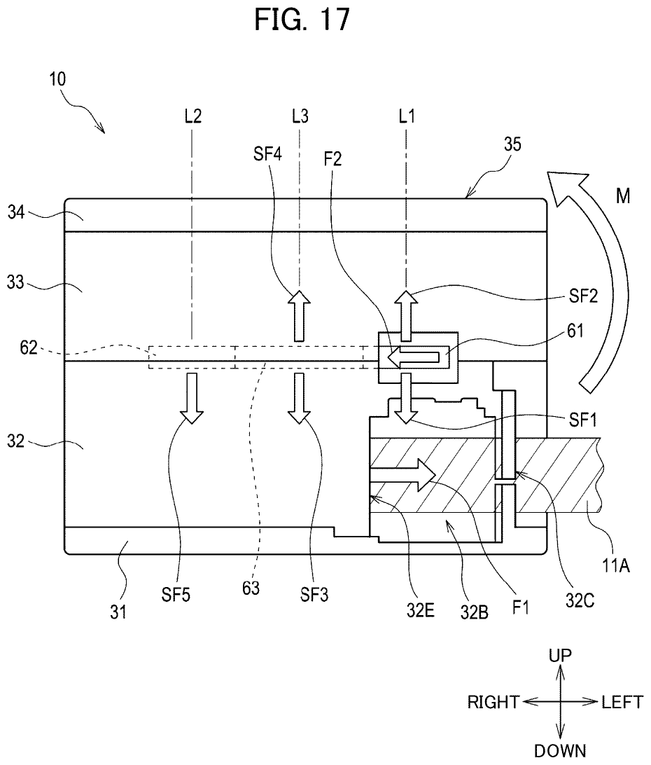

In the present embodiment, a downward first thrust load SF1 is generated at a center of the output gear 61 by a reaction force resulting from the meshing of the output gear 61 with the platen gear 103A, and the helix angle of their angled teeth, as illustrated in FIG. 17. The direction of the first thrust load SF1 is parallel to the rotational axis L1.

Incidentally, in FIG. 17, the output gear 61, input gear 62, and idle gear 63 are depicted schematically at different positions from their actual layout in the main case 35 in order to more clearly illustrate the relationship among the forces in the printing cassette 10.

An upward second thrust load SF2 is generated at the center of the output gear 61 and a downward third thrust load SF3 is generated at a center of the idle gear 63 by a reaction force resulting from the meshing of the output gear 61 with the idle gear 63, and the helix angle of their angled teeth. The directions of the second thrust load SF2 and third thrust load SF3 are both parallel to the rotational axis L1 of the output gear 61.

Further, an upward fourth thrust load SF4 is generated at the center of the idle gear 63, and a downward fifth thrust load SF5 is generated at a center of the input gear 62 by a reaction force resulting from the meshing of the input gear 62 with the idle gear 63 and the helix angle of their angled teeth. The directions of the fourth thrust load SF4 and fifth thrust load SF5 are both parallel to the rotational axis L1 of the output gear 61.

The magnitude of the first thrust load SF1 on the upstream side of the output gear 61 is equivalent to the magnitude of the second thrust load SF2 on the downstream side of the output gear 61 or is a magnitude obtained by subtracting transmission loss in the drive force (for example, less than 10%) from the magnitude of the second thrust load SF2. Therefore, a combined thrust load generated at the center of the output gear 61 is either zero or a minute upward load. Accordingly, influence of this combined force on the moment M is negligible.

The magnitude of the third thrust load SF3 on the upstream side of the idle gear 63 is equivalent to the magnitude of the fourth thrust load SF4 on the downstream side of the idle gear 63 or is a magnitude obtained by subtracting transmission loss in the drive force (for example, less than 10%) from the magnitude of the fourth thrust load SF4. Therefore, a combined thrust load generated at the center of the idle gear 63 is either zero or a minute upward load. Accordingly, influence of this combined force on the moment M is negligible.

Since the input gear 62 does not have angled teeth to be meshed with the drive shaft 105 of the printing device body 100, the fifth thrust load SF5 on the downstream side is the only load applied to the input gear 62. The rotational axis L2 of the input gear 62 passes through a position where, due to the moment M, a force acting in a direction for detaching the main case 35 from the cassette accommodation part 101 (i.e., upward) is received. Accordingly, the fifth thrust load SF5 can restrain the main case 35 from rising.

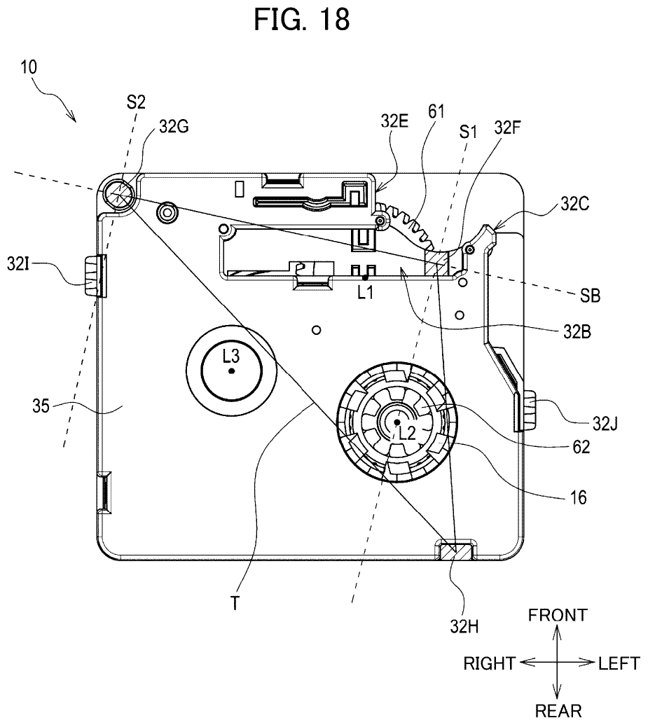

As illustrated in FIG. 18, when viewed in the up-down direction, the rotational axis L2 of the input gear 62 is positioned between the first virtual plane S1 passing through the first contact part 32F and the second virtual plane S2 passing through the second contact part 32G. The first virtual plane S1 and second virtual plane S2 are both parallel to the up-down direction and orthogonal to the reference virtual plane SB that passes through the first contact part 32F and second contact part 32G.

Further, when viewed in the up-down direction, there exists a virtual triangle T whose three vertices are respectively contained in the first contact part 32F, second contact part 32G, and third contact part 32H, and the rotational axis L1 of the output gear 61 and the rotational axis L2 of the input gear 62 are positioned inside the virtual triangle T.

### 3-2. Advantages

The embodiment described above obtains the following advantages.

(3a) Since the output gear 61, input gear 62, and idle gear 63 each include angled teeth, the fifth thrust load SF5 acting in the axial direction of the output gear 61 is produced in the printing cassette 10 when the output gear 61 and platen gear 103A are meshed with each other. This fifth thrust load SF5 can restrain the printing cassette 10 from tilting inside the printing device body 100.

(3b) The rotational axis L2 of the input gear 62 passes through a position where the upward force resulting from the moment M produced by the reaction force F2 generated on the output gear 61 and the resistance force F1 at the drawn-out part 32E is received. This structure can further contribute to suppression of the tilting of the printing cassette 10.

(3c) The three vertices of the virtual triangle T are contained in the first contact part 32F, second contact part 32G, and third contact part 32H, respectively, and the rotational axis L2 of the input gear 62 is positioned inside this virtual triangle T. With this structure, in a case where the fifth thrust load SF5 becomes excessive relative to the moment M, the load pressing the printing cassette 10 downward is to be distributed among the first contact part 32F, second contact part 32G, and third contact part 32H. As a result, the posture of the printing cassette 10 can be stabilized.

(3d) Since the input gear 62 has angled teeth, tiling of the printing cassette 10 attributed to the thrust load generated on the input gear 62, which is greater than the thrust load generated on the output gear 61, can be restrained.

### 4. Other Embodiments

While the embodiments of the present disclosure have been described above, it should be apparent that the present disclosure is not limited to the above embodiments and can be embodied in various forms.

(4a) The printing device in the above-described embodiments is not limited to a device configured to perform printing with an ink ribbon. For example, the printing device may perform printing on a strip-like thermal paper. That is, the printing cassette need not include an ink ribbon.

Further, the printing device may also employ stencil tapes as a printing tape, whereby a printing pattern is perforated in the stencil tape with a thermal head. In a case where a stencil tape is used as the printing tape, a laminating tape for protecting the stencil tape is used as an auxiliary tape in place of the ink ribbon.

(4b) In the printing cassette of the above embodiments, the printing tape roll and the drawn-out part may be at the same position in the up-down direction. Further, the drive transmission mechanism may be arranged above the printing tape roll or below the conveying path for the printing tape.

(4c) In the printing cassette of the above embodiment, the drive transmission mechanism may include, as the input part, a rotary body other than a gear (such as a roller) capable of transmitting the drive force.

(4d) The layout of each contact part in the printing cassette of the above embodiments is merely one example. That is, positions and the number of the contact parts in the printing cassette are not limited to those described above.

(4e) In the printing cassette of the above embodiments, the direction of the thrust load generated on the output gear due to meshing thereof with the platen gear may be opposite the direction in which the main case is inserted into the printing device body.

(4f) The functions possessed by a single component in the embodiments described above may be distributed among a plurality of components, and the functions possessed by a plurality of components may be integrated into a single component. Further, a part of the configurations in the above-described embodiments may be omitted. Further, at least a part of the configurations in the described embodiments may be added to or replaced in configurations in other embodiments. Incidentally, every aspect included in the technical concepts that can be identified from the recitations in the claims is the embodiments of the present disclosure.

What is claimed is:

1. A printing cassette comprising:
a tape roll including a tape to be used for printing, the tape being wound about an axis parallel to a first direction;
an input part into which a drive force from outside is to be inputted; and
an output gear rotatable about a rotational axis parallel to a second direction and configured to externally output the drive force inputted in the input part,
wherein the input part overlaps the tape roll when viewed in a direction parallel to the first direction, and
wherein
the output gear is a helical gear configured to generate a thrust load in the second direction when rotating, and
at least a part of the output gear overlaps the tape roll from the same side as the input part when viewed in the direction parallel to the first direction.

2. The printing cassette according to claim 1, further comprising a case that accommodates the tape roll therein,
wherein the case has a drawn-out part through which the tape is to be drawn out of the case in a drawn-out direction parallel to a third direction crossing the first direction, and
wherein the tape roll, the output gear, and the drawn-out part are arranged in order the tape roll, the output gear, and the drawn-out part in the first direction.

3. The printing cassette according to claim 2,
wherein the output gear has:
a first portion accommodated in the case; and
a second portion exposed outside the case, and
wherein the second portion is arranged at the same position as a part of the tape drawn out through the drawn-out part in the third direction.

4. The printing cassette according to claim 3,
wherein the second portion of the output gear has such a handedness that an end of a gear tooth closer to the drawn-out part in the second direction is positioned downstream in the drawn-out direction relative to an end of the gear tooth farther away from the drawn-out part in the second direction.

5. The printing cassette according to claim 2,
wherein the case has a first outer surface and a second outer surface between which the tape roll is interposed in the first direction, and
wherein the drawn-out part is arranged between the first outer surface and the second outer surface.

6. The printing cassette according to claim 1,
wherein the first direction and the second direction are parallel to each other.

7. The printing cassette according to claim 1, further comprising an auxiliary tape roll including an auxiliary tape to be used for printing,
wherein the auxiliary tape roll overlaps the tape roll from the same side as the input part when viewed in the direction parallel to the first direction.

8. The printing cassette according to claim 2,
wherein the case has a detection target part indicative of cassette identification information, and
wherein the detection target part is arranged at an opposite side of the output gear from the tape roll in the first direction and upstream of the output gear in the drawn-out direction of the tape.

9. The printing cassette according to claim 1,
wherein a helix angle of the output gear is not less than 20 degrees and not more than 30 degrees.

10. The printing cassette according to claim 1, further comprising an idle gear for transmitting the drive force inputted in the input part to the output gear,
wherein the idle gear is a stepped gear configured of an upstream gear and a downstream gear arranged coaxially with each other,
wherein the upstream gear is a spur gear, and
wherein the downstream gear is a helical gear meshing with the output gear.

11. The printing cassette according to claim 10,
wherein the upstream gear has a diameter larger than a diameter of the downstream gear.

12. The printing cassette according to claim 10,
wherein the downstream gear is arranged closer to the tape roll in the second direction than the upstream gear is to the tape roll.

13. The printing cassette according to claim 10,
wherein the input part includes an input gear meshing with the upstream gear.

14. The printing cassette according to claim 13,
wherein the rotational axis of the output gear, a rotational axis of the idle gear, and a rotational axis of the input gear are parallel to one another.

15. The printing cassette according to claim 1, further comprising:
an output part including the output gear; and
an idle gear for transmitting the drive force inputted in the input part to the output gear,
wherein the output part is a stepped gear configured of an auxiliary gear and the output gear arranged coaxially with each other, and
wherein the auxiliary gear is a spur gear meshing with the idle gear.

16. The printing cassette according to claim 15,
wherein the auxiliary gear has a diameter smaller than a diameter of the output gear.

17. The printing cassette according to claim 2,
wherein the case can be inserted into a printing device body in the second direction,
wherein the output gear is configured to mesh with a device-side gear provided in the printing device body to transmit the drive force for conveying the tape to the device-side gear, and
wherein the output gear has such a handedness that the thrust load is generated in an insertion direction of the case to the printing device body when the output gear rotates in a direction for transmitting the drive force to convey the tape toward the drawn-out part.

18. The printing cassette according to claim 17,
wherein the case is to receive a force for moving the case in a direction opposite the insertion direction due to a moment generated by a reaction force generated on the output gear at a meshing point between the output gear and the device-side gear and by a resistance force of the tape at the drawn-out part.

19. The printing cassette according to claim 17,
wherein the case has a first contact part, a second contact part and a third contact part arranged to be separated from one another and configured to contact the printing device body in the second direction.

20. The printing cassette according to claim 19,
wherein at least a part of the output gear is positioned opposite at least a part of the drawn-out part with respect to a virtual plane passing through the first contact part, the second contact part and the third contact part.

21. The printing cassette according to claim 19, further comprising an idle gear for transmitting the drive force inputted in the input part to the output gear,
wherein the idle gear is a stepped gear configured of an upstream gear and a downstream gear arranged coaxially with each other,
wherein the upstream gear is a spur gear,
wherein the downstream gear is a helical gear meshing with the output gear, and
wherein, when viewed in the second direction,
there exists a virtual triangle whose three vertices are contained respectively in the first contact part, the second contact part and the third contact part, and
a rotational axis of the idle gear being positioned inside the virtual triangle.

22. The printing cassette according to claim 17,
wherein the case includes a partitioning wall arranged between the tape roll and the output gear in the second direction, and
wherein the partitioning wall has a recess, the recess facing the device-side gear in a state where the case is inserted in the printing device body, a part of the device-side gear entering the recess when the thrust load is generated on the output gear.

23. The printing cassette according to claim 17,
wherein the first direction and the second direction are parallel to each other.
